(19) United States
(12) Patent Application Publication
(10) Pub. No.: US 2006/0064932 A1
(43) Pub. Date: Mar. 30, 2006

(54) Revolving-door assembly

(76) Inventor: Arie Ariav, Doar-Na Hof Ashkelon (IL)

Correspondence Address: Martin Moynihan;Anthony Castorina, 2001 Jefferson Davis Highway, Suite 207, Arlington, VA, 22202, US

(21) Appl. No.: 10/522,770

(22) PCT Filed: Jul. 24, 2003
(86) PCT No.: PCT/IL03/00613

§ 371 Date: Jan. 31, 2005

Related U.S. Application Data
(60) Provisional application No. 60/399,410, filed on Jul. 31, 2002.

(51) Int. Cl. E05D 15/02

(52) U.S. Cl. 49/42

(57) ABSTRACT

A revolving-door assembly includes a plurality of radially-extending door sections rotatably mounted about a vertical rotary axis within a passageway for controlling the flow of traffic through said passageway. Each of the radially-extending door sections includes a radially-extending inner panel and at least one radially-extending outer panel. The radially-extending inner panels are mounted for rotation about the vertical rotary axis. Each of the radially-extending outer panels is movable radially outwardly away from, and inwardly towards, the respective radially-extending inner panels to assume an outermost position when the respective radially-extending door section is located perpendicularly to the flow of traffic, and an innermost position when the respective radially-extending door section is located parallel to the flow of traffic. Two embodiments are described wherein there are four door sections, each including one or two outer panels; and two further embodiments are described wherein there are two door sections each including one or two outer panels.

### FIELD AND BACKGROUND OF THE INVENTION

The present invention relates to revolving-door assemblies, and particularly to such assemblies which include an array of radially-extending door sections rotatably mounted about a vertical rotary axis within a passageway for controlling the flow of traffic through the passageway.

Automatically controlled sliding door assemblies, such as illustrated in FIGS. 1a and 1b of the accompanying drawings, are commonly used for controlling the flow of traffic through passageways where the traffic is relatively heavy. However, as will be described below, sliding door assemblies require considerable space on each side of the passageway for the fixed sections of the doors. Such fixed sections of the doors are therefore not available for the flow of traffic when the door assembly is in its fully open position.

Revolving-door assemblies, such as illustrated in FIG. 2, both automatically driven and manually-driven, are also widely used for controlling the flow of traffic through passageways, particularly when it is desired to continuously block the unrestricted flow of air through the passageway, e.g., to prevent the escape of heated or cooled air to the outside. However, such door assemblies require considerable space both forwardly and rearwardly of the entrance to the respective passageway for accommodating the revolving-door assembly.

It will thus be seen that the conventional sliding-door assemblies have the advantages of relative simple and inexpensive construction, and the need for relatively small space forwardly and rearwardly of the passageway entrance/exit; but they have the disadvantage of requiring relatively large “dead” space laterally of the passageway, i.e., spaced not usable for passageway traffic. On the other hand, the conventional revolving-door assembly has, besides the advantage of blocking air through the passageway to conserve air-conditioning (heated or cooled air) within the building, also the advantage of requiring virtually no “dead” space laterally of the passageway not available for use by the traffic through the passageway, but they have the disadvantages of requiring relatively large space forwardly and rearwardly of the passageway entrance/exit.

### OBJECTS AND BRIEF SUMMARY OF THE PRESENT INVENTION

An object of the present invention is to provide a novel door assembly having advantages in the above respects over the conventional sliding-door assemblies and revolving-door assemblies. More particularly, an object of the present invention is to provide a novel door assembly which can be accommodated within the passageway in a minimum of space both laterally of the passageway, as well as forwardly and rearwardly of the passageway.

According to a broad aspect of the present invention, there is provided a revolving-door assembly comprising: a plurality of radially-extending door sections rotatably mounted about a vertical rotary axis within a passageway for controlling the flow of traffic through the passageway; each of the radially-extending door sections including a radially-extending inner panel and at least one radially-extending outer panel; the radially-extending inner panels being mounted for rotation about the vertical rotary axis; each of the radially-extending outer panels being movable radially outwardly away from, and radially inwardly towards, their respective radially-extending inner panels to assume an outermost position when the respective radially-extending door section is located perpendicularly to the flow of traffic, and an innermost position when the respective radially-extending door section is located parallel to the flow of traffic.

According to further features in the described preferred embodiments, each of the radially-extending outer panels includes movable coupling elements carried by the outer panels coupled to fixed coupling elements fixed within the passageway for effecting the radial movements of the radially-extending outer panels. In the described preferred embodiments, the movable coupling elements are carried by the outer ends of the radially-extending outer panels, and are coupled to tracks fixed to overlie and/or underlie the passageway.

Two embodiments are described below for purposes of example wherein there are four equally-spaced radially-extending door sections each including one of the inner panels, and one or two (or more) of the outer panels. Two further embodiments are described wherein there are only two diametrically-aligned door sections each including one of the inner panels, and one or two (or more) of the outer panels.

As will be described more particularly below, such a revolving-door assembly requires a minimum of space both laterally of the space defining the width of the passageway entrance, as well as forwardly and rearwardly of the passageway entrance. Such a revolving-door assembly thus includes many of the advantageous features of the conventional sliding-door assembly and of the conventional revolving-door assembly, and therefore can be considered to be a “hybrid” of the two types of conventional assemblies.

Further features and advantages of the invention will be apparent from the description below.

### BRIEF DESCRIPTION OF THE DRAWINGS

The invention is herein described, by way of example only, with reference to the accompanying drawings, wherein:

FIG. 1a schematically illustrates a conventional sliding-door assembly of the prior art in its fully-closed position;

FIG. 1b illustrates the sliding-door assembly of the prior art in its fully-open position;

FIG. 2 schematically illustrates a conventional prior art revolving-door assembly;

FIG. 3 schematically illustrates one embodiment of revolving-door assembly constructed in accordance with the present invention;

FIG. 4 illustrates a second embodiment of revolving-door assembly constructed in accordance with the present invention;

FIGS. 5 and 6 illustrate a third embodiment of revolving-door assembly constructed in accordance with the present invention in the closed and open position, respectively of the door assembly; and

FIGS. 7 and 8 illustrate a fourth embodiment of revolving-door assembly constructed in accordance with the present invention, in the closed and open position, respectively, of the assembly.

It is to be understood that the foregoing drawings, and the description below, are provided primarily for purposes of facilitating understanding the conceptual aspects of the invention and various possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

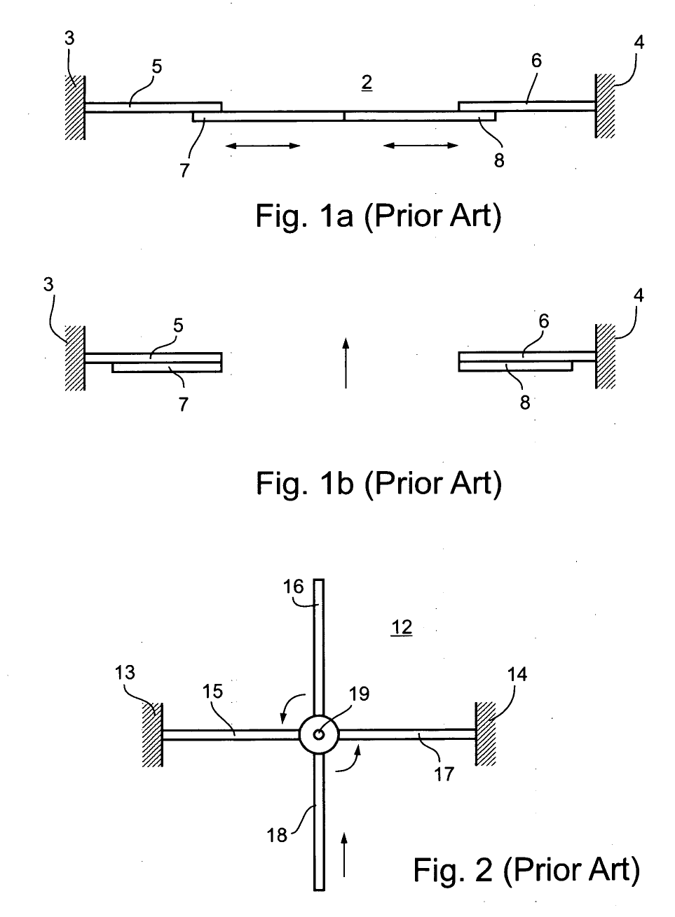

### DESCRIPTION OF THE PRIOR ART (FIGS. 1A, 1B AND 2)

FIGS. 1a and 1b illustrate a conventional prior art sliding-door assembly for controlling the flow of traffic through a passageway, generally designated 2, defined by two fixed elements 3, 4, such as door frames, walls, or the like. The sliding door assembly illustrated in FIG. 1a includes two panels 5, 6, fixed to the opposed sides 3, 4 defining the entrance 2, and a pair of sliding panels 7, 8, each slidably mounted with respect to one of the fixed panels 5, 6 towards and away from the other sliding panel. The dimensions of panels 5-8 are such that when the door assembly is closed, as illustrated in FIG. 1a, the two sliding panels 7, 8 having been moved inwardly unto an abutting relationship, cooperate with the fixed panels 5, 6 to completely close the passageway 2 for the flow of traffic; and when the door assembly is in its fully open position, as illustrated in FIG. 1b, the two sliding panels 7, 8 have been moved outwardly so as to be spaced from each other, while aligned with their respective fixed panels 5, 6, and thereby fully open the passageway 2 to the flow of traffic.

As indicated earlier, a disadvantage of the conventional sliding-door assembly illustrated in FIGS. 1a and 1b is that a considerable amount of the passageway space is taken up by the fixed panels 5, 6 in the fully open position of the door assembly, and is therefore not available for the flow of traffic through passageway 2, as illustrated in FIG. 1b. For example, in a typical installation, the space of the passageway 2 open for the flow of traffic in the fully-open position of the sliding-door assembly may be in the order of 50% of the distance between the width of the passageway 2 defined by the opposed elements 3, 4.

FIG. 2 illustrates a conventional prior art revolving-door assembly mounted within a passageway 12 for controlling the flow of traffic through the passageway. In this case, passageway 12 is also defined by the opposed fixed elements 13, 14, such as a door frame. The revolving-door assembly illustrated in FIG. 2 includes an array of radially-extending door sections 15, 16, 17, 18, rotatably mounted about a vertical rotary axis 19, centrally of passageway 12, e.g., by a drive coupled to the door sections centrally of the passageway.

The conventional revolving-door assembly as illustrated in FIG. 2 has the advantage, as compared to the sliding-door assembly of FIGS. 1a and 1b, of continuously blocking the flow of air through the passageway 12, and thereby of better conserving heated or cooled air from dissipation through the passageway. However, as indicated earlier, such a door assembly requires considerable space forwardly and rearwardly of the passageway entrance to accommodate the door assembly.

### DESCRIPTION OF PREFERRED EMBODIMENTS OF THE PRESENT INVENTION

As indicated earlier, the present invention provides a revolving-door assembly which is different from both of the conventional prior art door assemblies illustrated in FIGS. 1a, 1b and 2, and which provides a number of advantages over both types of door assemblies. Briefly, the present invention provides a revolving-door assembly somewhat similar to the prior art of FIG. 2 but in which each of the radially-extending door sections includes a radially-extending inner panel and at least one radially-extending outer panel. Each of the radially-extending inner panels is mounted for rotation about the vertical rotary axis of the revolving-door assembly. Each of the radially-extending outer panels is movable radially outwardly away from, and inwardly towards, its respective radially-extending inner panel to assume an outermost position when the respective radially-extending door section is located perpendicularly to the flow of traffic, and an innermost position when the respective radially-extending door section is located parallel to the flow of traffic.

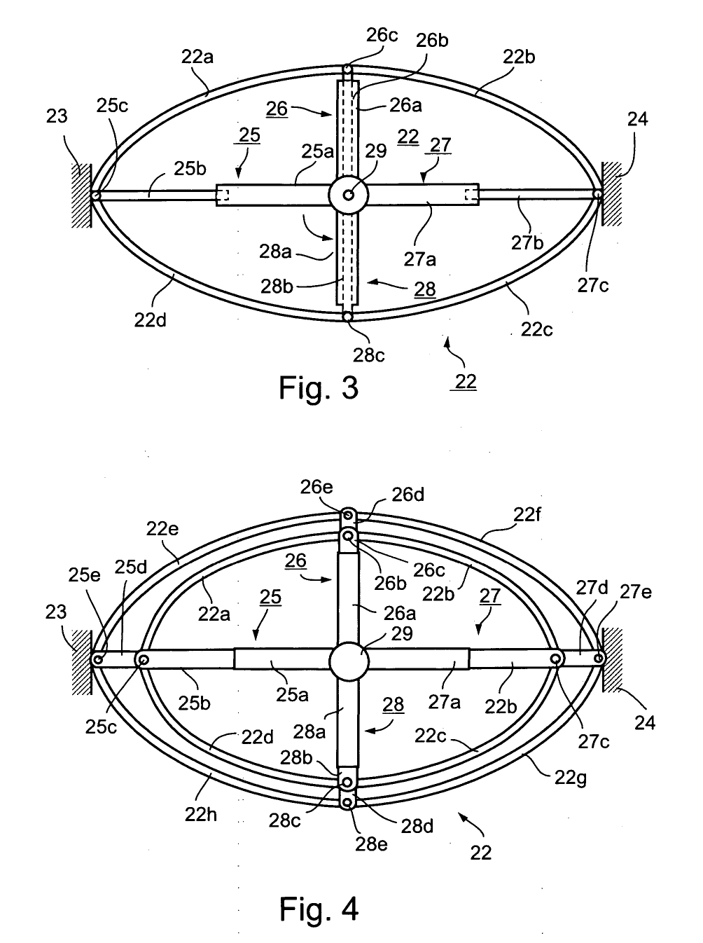

FIG. 3 illustrates a revolving-door assembly constructed in accordance with the present invention mounted within a passageway 22 defined by opposed frame elements 23, 24 for controlling the flow of traffic through the passageway. The illustrated revolving-door assembly illustrated in FIG. 3 also includes, as in the conventional prior art assembly illustrated in FIG. 2, an array of four equally-spaced, radially-extending door sections 25, 26, 27, 28 rotatably mounted about a vertical rotary axis 29 within passageway 22 for controlling the flow of traffic through the passageway. In this case, however, each of the radially-extending door sections 25-28 includes an inner panel 25a-28a, respectively, mounted for rotation about the vertical axis 29, and a single outer panel 25b-28b, respectively, movable radially towards and away from their respective inner panels.

For moving the outer panels 25b-28b, each such outer panel is provided with a fixed element, such as a roller or other projection 25c-28c, respectively, at the outer end of the respective outer panel. Such rollers or projections are received within tracks 22a-22d fixed to overlie and/or underlie the passageway 22. The tracks 22a-22d are configured so as to move their outer panels 25b-28b radially towards and away from their respective inner panels 25a-28a during the rotation of the revolving-door assembly. The arrangement is such each of that the outer panels 25b-28d assumes its outermost radial position when the respective radially-extending door section is located perpendicularly to the flow of traffic (as is the case with respect to radially-extending sections 25 and 27 in FIG. 3), and assumes its radial innermost position when the respective radially-extending door section is located parallel to the flow of traffic (as the case of radially-extending sections 26 and 28 in FIG. 3).

The revolving-door assembly illustrated FIG. 3 thus provides the advantages, over the conventional revolving-door assembly illustrated in FIG. 2, of requiring considerably less space, forwardly and rearwardly of the entrance to passageway 22, for accommodating the radially-extending door sections of the assembly.

FIG. 4 illustrates another revolving-door assembly constructed in accordance with the present invention which requires even less space forwardly and rearwardly of the entrance to the passageway than the assembly illustrated in FIG. 3. In order to provide this advantage, the revolving-door assembly illustrated in FIG. 4 includes two outer door panels, rather than a single outer door panel, for each radially-extending door section, movable radially towards and away from the respective inner panel of the door section.

Thus, the revolving-door assembly illustrated in FIG. 4 is similarly constructed as in FIG. 3, and to facilitate understanding, the generally corresponding elements are correspondingly numbered. In the revolving-door assembly illustrated in FIG. 4, however, each of the radially-extending door sections 26-28 includes a second outer panel 25d-28d, respectively, formed with a projection or roller 25e-28e, the latter projections being movable within a second group of slots 22e-22h, outwardly of the first group of slots 22a-22d, for moving the second outer panel 25d-28d, radially inwardly and outwardly in the same manner as described above with respect to FIG. 3.

The embodiments of the invention illustrated in FIGS. 3 and 4 can thus be implemented in conventional revolving-door assembly constructions, to provide the advantages of such constructions of blocking air through the passageway to conserve air conditioning, and of requiring virtually no “dead” space laterally of the passageway not available for use by the traffic through the passageway, without the disadvantage of such conventional constructions of requiring relatively large space forwardly and rearwardly of the passageway entrance/exit. The latter disadvantage of revolving-door assemblies is a main advantage of the conventional sliding-door assembly which requires relatively small space forwardly and rearwardly of the passageway entrance/exit. Accordingly, the embodiments of the invention illustrated in FIGS. 3 and 4 combine many of the advantages of the revolving-door assembly and the sliding-door assembly without their respective main disadvantages.

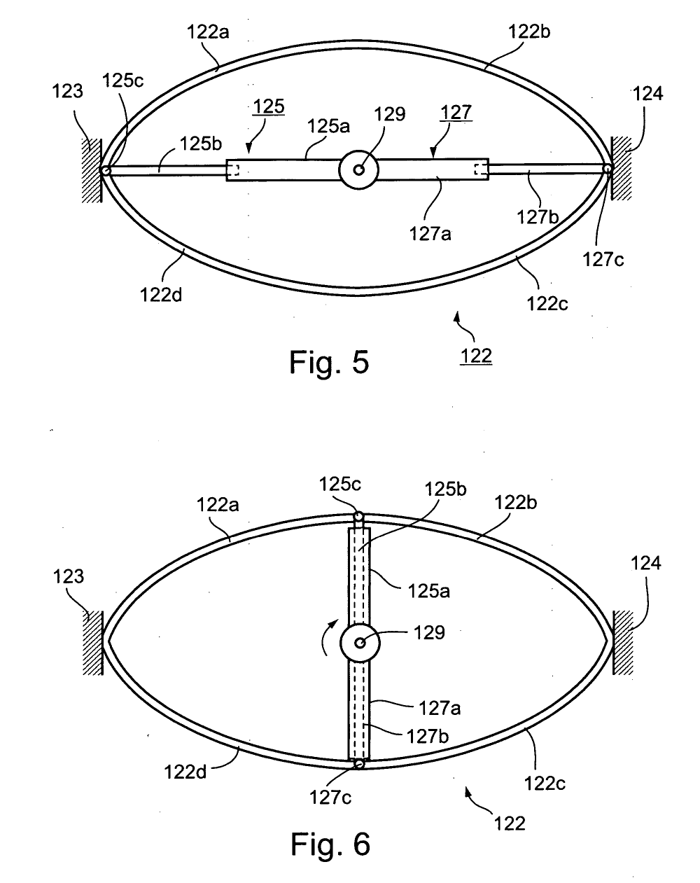

FIGS. 5-8 illustrate two further embodiments of the invention also combining advantages of the two types of door assemblies without some of their disadvantages.

Thus, FIGS. 5 and 6 illustrate a revolving-door assembly constructed as described above with respect to FIG. 3, except that, instead of having four equally-spaced door sections with each including a radially-extending inner panel and a radially-extending outer panel, the revolving-door assembly includes only two diametrically-aligned door sections with each including a radially-extending inner panel and a radially-extending outer panel. Thus, such a revolving-door assembly would be constructed as described above with respect to FIG. 3, except that two of the door sections, namely sections 26 and 28, would be omitted with their respective inner and outer panels, so that the revolving-door assembly would include only the two door sections 25, 27, with their respective inner and outer panels.

To facilitate understanding, the various elements referred to in the embodiment illustrated in FIGS. 5 and 6 (FIG. 5 showing the closed position, and FIG. 6 showing the open position), are identified by the same reference numerals as used in FIG. 3, but increased by “100”.

Thus, as shown in FIGS. 5 and 6, the revolving-door assembly therein illustrated is provided for controlling the flow of traffic through the passageway 122 defined by opposed frame elements 123, 124. The revolving-door assembly includes, instead of four equally-spaced radially-extending door sections (25, 26, 27, 28, FIG. 3) two diametrically-aligned door sections 125, 127, rotatably mounted about the vertical rotary axis 129 within passageway 122 for controlling the flow of traffic through the passageway. Each of the radially-extending door sections 125, 127 also includes an inner panel 125a, 127a, and an outer panel 125b, 127b, movable radially towards and away from their respective inner panels.

For moving the outer panels 125b, 127b, each such outer panel is provided with a fixed element, such as a roller or other projection 125c, 127c at the outer end of the respective outer panel, received within tracks 122a-122d, fixed to overlie and/or underlie the passageway 122. The arrangement is such, as described above with respect to FIG. 3, that the outer panels 125b, 127b, assume their outermost radial positions when the respective radially-extending door section is located perpendicularly to the flow of traffic, as shown in FIG. 5, and assume their radial innermost position when the respective radially-extending door section is located parallel to the flow of traffic, as shown in FIG. 6.

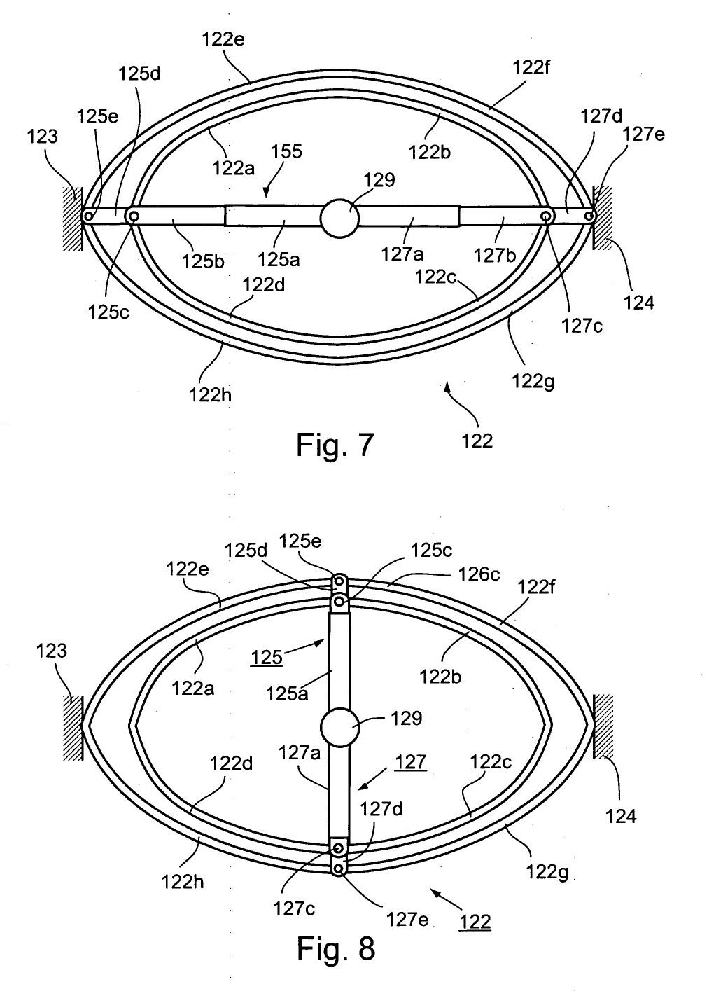

FIGS. 7 and 8 illustrate the closed and open positions, respectively, of a revolving-door assembly constructed as in FIG. 4, but also including only two diametrically-aligned door sections 125, 127 each including an inner panel 125a, 127a, and two outer panels 125b, 125d, and 127b, 127d, together with their respective projections 125c, 127c and their respective tracks 122a-122d and 122e-122h.

It will thus be seen that the revolving-door assembly illustrated in FIGS. 7 and 8 operates in the same manner as described above with respect to FIG. 4, except that it includes only the two diametrically-aligned door sections 125, 127, rather than the four equally-spaced door sections 25-28 of FIG. 4.

It will also be seen that the embodiments illustrated in FIGS. 5, 6 and 7, 8, respectively, provide the same advantages as described above with respect to FIGS. 3 and 4, except that the advantage of blocking air through the passageway to conserve air conditioning is offset by the advantage of simplifying and reducing the expense of the construction.

The invention could be implemented in other door assemblies, for example door assemblies including three door sections, or more than four door sections, or including more than two movable outer panels for each door section, according to the particular application of the respective door assembly.

Accordingly, while the invention has been described with respect to four preferred embodiments, it will be appreciated that these are set forth merely for purposes of example, and that many other variations, modifications and applications of the invention may be made.

What is claimed is:

1. A revolving-door assembly comprising:
a plurality of radially-extending door sections rotatably mounted about a vertical rotary axis within a passageway for controlling the flow of traffic through said passageway;
each of said radially-extending door sections including a radially-extending inner panel and at least one radially-extending outer panel;
said radially-extending inner panels being mounted for rotation about said vertical rotary axis;
each of said radially-extending outer panels being movable radially outwardly away from, and inwardly towards, the respective radially-extending inner panels to assume an outermost position when the respective radially-extending door section is located perpendicularly to said flow of traffic, and an innermost position when the respective radially-extending door section is located parallel to said flow of traffic.

2. The revolving-door assembly according to claim 1, wherein each of said radially-extending outer panels includes movable coupling elements carried by the outer panels coupled to fixed coupling elements fixed within said passageway for effecting said radial movements of the radially-extending outer panels.

3. The revolving-door assembly according to claim 2, wherein said movable coupling elements are carried by the outer ends of said radially-extending outer panels, and are coupled to tracks fixed to overlie and/or underlie said passageway.

4. The revolving-door assembly according to claim 1, wherein each of said radially-extending door sections includes one of said inner panels and one of said outer panels.

5. The revolving-door assembly according to claim 1, wherein each of said radially-extending door sections includes one of said inner panels and at least two of said outer panels.

6. The revolving-door assembly according to claim 1, wherein said plurality of radially-extending door sections includes four equally-spaced door sections, each including a radially-extending inner panel and at least one radially-extending outer panel.

7. The revolving-door assembly according to claim 6, wherein each of said radially-extending door sections includes one of said inner panels and one of said outer panels.

8. The revolving-door assembly according to claim 6, wherein each of said radially-extending door sections includes one of said inner panels and at least two of said outer panels.

9. The revolving-door assembly according to claim 6, wherein each of said radially-extending outer panels includes movable coupling elements carried by the outer panels coupled to fixed coupling elements fixed within said passageway for effecting said radial movements of the radially-extending outer panels.

10. The revolving-door assembly according to claim 6, wherein said movable coupling elements are carried by the outer ends of said radially-extending outer panels, and are coupled to tracks fixed to overlie and/or underlie said passageway.

11. The revolving-door assembly according to claim 1, wherein said plurality of radially-extending door sections includes two diametrically-aligned door sections, each including a radially-extending inner panel and at least one radially-extending outer panel.

12. The revolving-door assembly according to claim 11, wherein each of said radially-extending door sections includes one of said inner panels and one of said outer panels.

13. The revolving-door assembly according to claim 11, wherein each of said radially-extending door sections includes one of said inner panels and at least two of said outer panels.

14. The revolving-door assembly according to claim 11, wherein each of said radially-extending outer panels includes movable coupling elements carried by the outer panels coupled to fixed coupling elements fixed within said passageway for effecting said radial movements of the radially-extending outer panels.

15. The revolving-door assembly according to claim 11, wherein said movable coupling elements are carried by the outer ends of said radially-extending outer panels, and are coupled to tracks fixed to overlie and/or underlie said passageway.

16. A revolving-door assembly comprising:
four equally-spaced radially-extending door sections rotatably mounted about a vertical rotary axis within a passageway for controlling the flow of traffic through said passageway,
each of said radially-extending door sections including a radially-extending inner panel and at least one radially-extending outer panel;
said radially-extending inner panels being mounted for rotation about said vertical rotary axis;
each of said radially-extending outer panels being movable radially outwardly away from, and inwardly towards, the respective radially-extending inner panels to assume an outermost position when the respective radially-extending door section is located perpendicularly to said flow of traffic, and an innermost position when the respective radially-extending door section is located parallel to said flow of traffic.

17. The revolving-door assembly according to claim 16, wherein each of said radially-extending door sections includes one of said inner panels and one of said outer panels.

18. The revolving-door assembly according to claim 16, wherein each of said radially-extending door sections includes one of said inner panels and at least two of said outer panels.

19. A revolving-door assembly comprising:
two diametrically-aligned door sections rotatably mounted about a vertical rotary axis within a passageway for controlling the flow of traffic through said passageway;
each of said diametrically-aligned door sections including a radially-extending inner panel and at least one radially-extending outer panel;
said radially-extending inner panels being mounted for rotation about said vertical rotary axis;
each of said radially-extending outer panels being movable radially outwardly away from, and inwardly towards, the respective radially-extending inner panels to assume an outermost position when the respective diametrically-aligned door section is located perpendicularly to said flow of traffic, and an innermost position when the respective diametrically-aligned door section is located parallel to said flow of traffic.

20. The revolving-door assembly according to claim 19, wherein each of said diametrically-aligned door sections includes one of said inner panels and one of said outer panels.

21. The revolving-door assembly according to claim 19, wherein each of said diametrically-aligned door sections includes one of said inner panels and at least two of said outer panels.
